(19) United States
(12) Patent Application Publication
(10) Pub. No.: US 2024/0208163 A1
(43) Pub. Date: Jun. 27, 2024

(54) DEVICE AND METHOD FOR CUTTING AN INTERMEDIATE PRODUCT MADE OF RUBBER

(71) Applicant: COMPAGNIE GENERALE DES ETABLISSEMENTS MICHELIN, Clermont-Ferrand (FR)

(72) Inventor: MARIE CROUZET, Clermont-Ferrand (FR)

(21) Appl. No.: 18/288,657

(22) PCT Filed: Apr. 28, 2022
(86) PCT No.: PCT/FR2022/050806

§ 371 Date: Oct. 27, 2023

(30) Foreign Application Priority Data
Apr. 30, 2021 (FR) FR2104556

(51) Int. Cl. B29C 70/54; B29D 30/06; B29K 21/00; B29K 105/10

(52) U.S. Cl. CPC B29C 70/545; B29D 30/06; B29K 2021/00; B29K 2105/106

(57) ABSTRACT

A device for cutting an intermediate product made of rubber, the intermediate product comprising filamentary reinforcing elements embedded in the rubber and parallel to one another, comprises a support, a blade, and a blade holder movable between an open position and a closed position in which the blade comes into contact with the support. The blade is loosely mounted on the blade holder so that the blade is pivotable and/or movable in translation relative to the blade holder.

The invention lies in the field of the manufacture of products based on rubber and, more specifically, in the field of the cutting of intermediate products involved in the manufacture of a tyre or a wheel.

The manufacture of a tyre or a wheel comprises numerous steps of cutting intermediate products taking various shapes, generally longitudinal and profiled shapes, such as plies or strips obtained by calendering or extrusion methods. Certain intermediate products are based on rubber, preferably in the uncured state, and also comprise filamentary reinforcing elements, embedded in the uncured rubber, and parallel to each other.

The production of a straight cut of reinforced intermediate products comprises two variants depending on whether one wishes to obtain a straight cut parallel to the filamentary reinforcing elements, made in raw rubber, or a straight cut forming an angle with the filamentary reinforcing elements and, consequently, severing the filamentary reinforcing elements.

Obtaining a straight cut according to the first variant proves to be particularly difficult without severing the adjacent filamentary reinforcing elements by mistake. Consequently, the cutting means used for making a straight cut are generally designed to be resistant to wear or breakage in order to sever filamentary reinforcing elements, which proves to be expensive.

In order to make a straight cut parallel to the filamentary reinforcing elements, a method is known using a chisel which is inserted on one side of an intermediate product into the raw rubber between two filamentary elements, which is moved in a direction generally parallel to the filamentary reinforcing elements, with precise guiding of the chisel being ensured by the two filamentary elements, and which is extracted on another side of the intermediate product.

Such a method is particularly suitable when the intermediate product is intended to be assembled on a tyre blank using an assembly drum, since the cutting can be carried out at the same time as the assembly, without introducing manipulations of the cut intermediate product.

However, such a method is not suitable when the intermediate product is intended to be moulded, because the straight cut cannot be made in parallel, and introduces, prior to the moulding, one or more manipulations of the cut intermediate product.

There is therefore a need for a method for cutting reinforced intermediate products that overcomes these drawbacks.

Consequently, the invention proposes a device for cutting an intermediate product made of rubber, the intermediate product comprising filamentary reinforcing elements embedded in the rubber and parallel to one another, the cutting device comprising a support, a blade, and a blade holder movable between an open position and a closed position in which the blade comes into contact with the support.

According to the invention, the blade is loosely mounted on the blade holder so that the blade is pivotable and/or movable in translation relative to the blade holder.

The blade has a longitudinal direction, a transverse direction, and a yaw direction substantially parallel to a closing direction of the blade holder. The blade is pivotable around, and/or movable in translation along, one or more of said directions relative to the blade holder.

Preferably, the intermediate product is based on raw rubber.

When the blade holder is brought into the closed position, the intermediate product having been previously positioned so that its filamentary reinforcing elements are substantially parallel to the longitudinal direction of the blade in the closed position of the blade holder, the blade penetrates into the raw rubber of the intermediate product and causes it to flow on either side of the blade. Then, upon possible contact with one of the filamentary reinforcing elements, the blade pivots and/or translates until it can slide over the edge of said element, or even push it back.

Thus, the cut is made without severing filamentary reinforcing elements, so that the cutting edge of the blade is less stressed and wears less quickly.

Preferably, the blade holder comprises a housing, in which the blade is mounted, which makes it possible to limit the pivoting and the translation of the blade.

The amplitude in pivoting and in translation of the blade allows it to compensate for a lack of parallelism between the filamentary reinforcing elements and the longitudinal direction of the blade in the closed position of the blade holder, which is less than or equal to a pitch spacing the filamentary reinforcing elements.

By way of example, the blade is free in rotation around said directions by an angle ranging from plus to minus 2.5°, and free in translation along said directions by a distance ranging from plus to minus 2.5 mm, relative to a position in which the blade is centred in its housing.

By way of example, the pitch spacing the filamentary reinforcing elements varies from 0.5 to 10 mm.

Advantageously, the blade translates only along a yaw direction relative to the blade holder, the other possibilities of movement of the blade relative to the blade holder being substantially eliminated.

In other words, the possibilities of movement of the blade relative to the blade holder, other than translation along the yaw direction, are greatly limited.

By way of example, the blade is strongly limited in rotation around the directions concerned by an angle ranging from plus to minus 0.25°, and strongly limited in translation along the directions concerned by a distance ranging from plus to minus 0.25 mm, relative to a position in which the blade is centred in its housing.

By way of example, the amplitude in translation of the blade along the yaw direction varies from 0.5 mm to 10 mm.

Thus, the construction of the cutting device is optimized, while maintaining efficient operation.

Advantageously, the cutting device comprises elastic means arranged between the blade and the blade holder.

When the blade comes into possible contact with one of the filamentary reinforcing elements, it is immobilized and the blade holder continues its movement towards the closed position by compressing the elastic means. When the elastic means exert sufficient stress on the blade, the blade pushes back said element, then slides over its edge.

Thus, the cut is made neatly and without burrs.

Preferably, in the closed position of the blade holder, the elastic means exert sufficient stress on the blade to allow the blade to slide between two filamentary reinforcing elements by causing the raw rubber to flow, but this stress being less than the closing stress applied to the blade holder and/or the stress capable of severing one of the filamentary reinforcing elements.

The sufficient stress depends in particular on the shape and orientation of the blade, the physical properties of the raw rubber, the thickness of the intermediate product, the length of the cut, the pitch and the diameter of the filamentary reinforcing elements.

By way of example, the diameter of the filamentary reinforcing elements varies from 0.2 to 5 mm.

Advantageously, the support has a notch into which the blade is inserted when the blade holder is brought into the closed position.

Thus, the cutting edge of the blade does not bear directly on the support, so that the blade is stressed less and wears out less quickly.

The invention also relates to a curing mould for an intermediate product, comprising at least one cutting device according to a previous subject of the invention, at least two moulding cavities for cut intermediate products, the cutting device being arranged so that the open position of the cutting device corresponds to the open position of the mould, and that the closed position of the cutting device corresponds to the closed position of the mould.

Preferably, the mould comprises an upper part and a lower part which join, when the mould is in the closed position, along a contour, said contour dividing each moulding cavity. The upper part of the mould comprises the upper divisions of the cavities, the blade holder and the blade. The lower part of the mould comprises the lower divisions of the cavities, and the support.

When the mould is brought into the closed position, the cutting device cuts the intermediate product, the intermediate product having been previously positioned in the mould so that its filamentary reinforcing elements are substantially parallel to the longitudinal direction of the blade. The cut intermediate products are then cured in each of the moulding cavities.

Thus, the intermediate product is cut in parallel, during the closing of the mould, and the cutting method according to the invention does not introduce, prior to the moulding, one or more manipulations of the cut intermediate product, unlike the cutting and curing device of the prior art.

Preferably, the elastic means exert sufficient stress on the blade to allow the blade to slide between two filamentary reinforcing elements by causing the raw rubber to flow, the intermediate product being subjected, when the mould is in the closed position, to a given moulding pressure.

The moulding pressure depends in particular on the shape of the cavity with regard to that of the intermediate product, the viscosity of the raw rubber, the volume and the orientation of the blade, the pitch and the diameter of the filamentary reinforcing elements.

By way of example, the moulding pressure inside the mould varies from 1 to 50 bar.

Advantageously, in the closed position of the mould, the blade forms a separation between each cavity.

Thus, the side walls of the blade form part of the moulding surface of the curing mould.

Advantageously, the thickness of the blade is less than or equal to 2 mm and, preferably, less than or equal to 1 mm.

Thus, the stress sufficient to allow the blade to slide between two filamentary reinforcing elements is limited.

Furthermore, with the cross section of the blade also being limited, the stress to which it is subjected due to the moulding pressure is reduced.

Advantageously, the curing mould comprises means for positioning the intermediate product.

Preferably, the positioning means are formed by the lower divisions of the cavities.

Thus, the positioning means allow rapid positioning of the intermediate product on the support, so that its filamentary reinforcing elements are substantially parallel to the longitudinal direction of the blade in the closed position of the blade holder.

The invention also relates to a method for moulding an intermediate product made of rubber using a curing mould according to a previous subject of the invention, the method comprising the following steps:
the intermediate product is positioned on the support so that the filamentary reinforcing elements are substantially parallel to the longitudinal direction of the blade in the closed position of the mould,
the blade holder is brought into the closed position.

Thus, the intermediate product can be positioned approximately, the blade being capable of compensating for a lack of parallelism between the filamentary reinforcing elements and the longitudinal direction of the blade in the closed position of the blade holder.

Advantageously, prior to the step of positioning the intermediate product, the intermediate product is pre-cut.

Thus, the blade is guided by the pre-cut in the intermediate product, which facilitates its cutting.

Furthermore, the volume of rubber of the intermediate product to be caused to flow on either side of the blade is reduced, and the stresses exerted on the blade are reduced.

The invention will be understood better from the remainder of the description, which is based on the following figures:

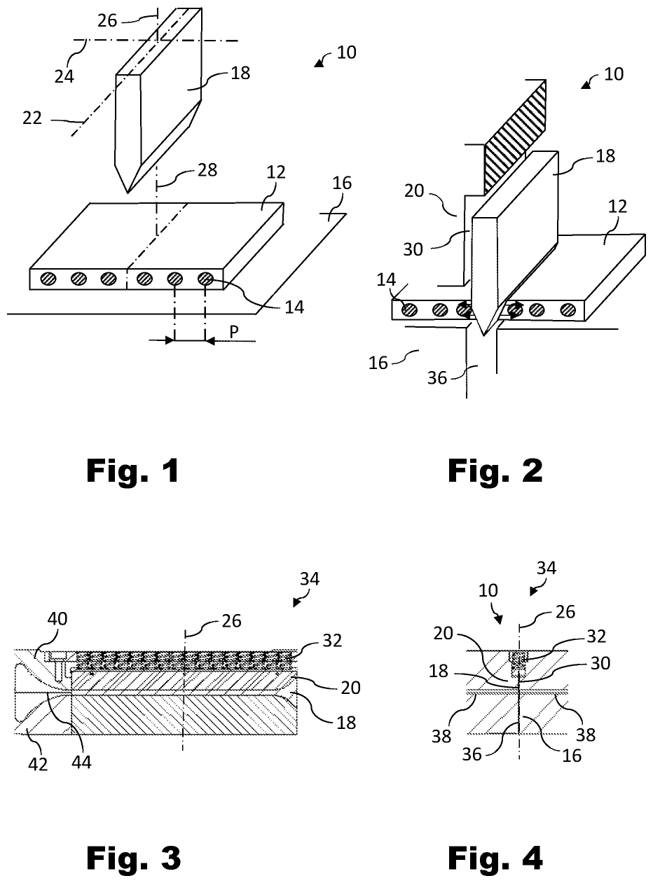

FIG. 1 is a simplified view of certain elements of the cutting device according to the invention in the open position;

FIG. 2 is a simplified view of certain elements of the cutting device according to the invention moving towards a closed position;

FIG. 3 is a longitudinal sectional view of the invention according to a preferred embodiment;

FIG. 4 is a longitudinal sectional view of the invention according to a preferred embodiment.

In the various figures, identical or similar elements carry the same reference. Their description is therefore not systematically repeated.

FIGS. 1 and 2 illustrate a device 10 for cutting an intermediate product 12 made of raw rubber, the intermediate product comprising filamentary reinforcing elements 14 embedded in the rubber and parallel to one another. By way of example, the filamentary reinforcing elements are synthetic or metallic, and their diameter ranges from 0.2 to 5 mm, and the pitch P spacing the filamentary reinforcing elements ranges from 0.5 to 10 mm. The cutting device 10 comprises a support 16, a blade 18, and a blade holder 20 movable between an open position and a closed position in which the blade comes into contact with the support. The thickness of the blade 18 is less than or equal to 2 mm and, preferably, less than or equal to 1 mm.

The blade 18 is loosely mounted on the blade holder 20 so that the blade is pivotable and/or movable in translation relative to the blade holder. The blade has a longitudinal direction 22, a transverse direction 24, and a yaw direction 26 substantially parallel to a closing direction 28 of the blade holder. The blade is pivotable around, and/or movable in translation along, one or more of said directions relative to the blade holder. The blade holder comprises a housing 30, in which the blade is mounted, which makes it possible to limit the pivoting and the translation of the blade. The blade 18 is connected to the blade holder 20 by any suitable means (not shown). By way of example, the blade can be connected to the blade holder by means of rivets fixed in the blade holder and passing through holes in the blade in a loose manner.

According to a preferred embodiment of the invention illustrated in FIGS. 3 and 4, the blade 18 translates only along a yaw direction 26 relative to the blade holder 20. The blade is mounted in the blade holder with a suitable fit allowing it to slide freely in the housing 30 and, consequently, to form a sliding connection with the blade holder. By way of example, the blade 18 can slide along the yaw direction 26 with an amplitude ranging from 0.5 mm to 10 mm. The other possibilities of movement of the blade relative to the blade holder are substantially eliminated. In other words, the possibilities of movement of the blade relative to the blade holder, other than translation along the yaw direction, are greatly limited. By way of example, the blade is strongly limited in rotation around the directions concerned by an angle ranging from plus to minus 0.25°, and strongly limited in translation along the directions concerned by a distance ranging from plus to minus 0.25 mm, relative to a position in which the blade is centred in the housing.

The cutting device comprises elastic means 32 arranged in the housing 30, between the blade 18 and the blade holder 20. By way of example, the elastic means can take the form of helical springs or stacks of elastic washers. In the closed position of the blade holder 20, the elastic means 32 exert sufficient stress on the blade 18 to allow the blade to slide between two filamentary reinforcing elements 14 by causing the raw rubber to flow, but which stress is less than the closing stress applied to the blade holder and/or the stress capable of severing one of the filamentary reinforcing elements 14. The sufficient stress depends in particular on the shape and orientation of the blade, the physical properties of the raw rubber, the thickness of the intermediate product, the length of the cut, the pitch and the diameter of the filamentary reinforcing elements.

FIGS. 3 and 4 also illustrate a curing mould 34 for an intermediate product 12, comprising at least one cutting device 10, at least two cavities 38 for moulding cut intermediate products. The cutting device 10 is arranged so that the open position ofthe cutting device corresponds to the open position of the mould, and the closed position of the cutting device corresponds to the closed position of the mould. In the closed position of the mould 34, the blade 18 forms a separation between each cavity 38. In other words, the side walls of the blade form part of the moulding surface of the curing mould. The support 16 has a notch 36 into which the blade 18 is inserted when the blade holder 20 is brought into the closed position. The mould 34 comprises means for positioning the intermediate product, formed by the lower divisions of the cavities 38.

The mould 34 comprises an upper part 40 and a lower part 42 which join, when the mould is in the closed position, along a contour 44, said contour dividing each cavity 38. The upper part 40 of the mould comprises the upper divisions of the cavities, the blade holder 20 and the blade 18. The lower part 42 of the mould comprises the lower divisions of the cavities, and the support 16. The elastic means 32 exert sufficient stress on the blade 18 to allow the blade to slide between two filamentary reinforcing elements 14 by causing the raw rubber to flow, the intermediate product 12 being subjected, when the mould 34 is in the closed position, to a given moulding pressure. The moulding pressure depends in particular on the shape of a cavity with regard to that of the intermediate product 12, the viscosity of the raw rubber, the volume and the orientation of the blade 18, the pitch and the diameter of the filamentary reinforcing elements 14. By way of example, the moulding pressure inside the mould 34 varies from 1 to 50 bar.

A method for moulding an intermediate product 12 made of rubber, using a curing mould 34, comprises the following steps:
optionally, the intermediate product 12 is pre-cut,
the intermediate product 12 is positioned, using the positioning means, on the support 16 so that the filamentary reinforcing elements 14 are substantially parallel to the longitudinal direction 22 of the blade 18 in the closed position of the mould,
the blade holder 20 is brought into the closed position.

When the blade holder 20 is brought into the closed position, the blade 18 penetrates into the raw rubber of the intermediate product 12 and causes it to flow on either side of the blade. Then, upon possible contact with one of the filamentary reinforcing elements 14, the blade pivots and/or translates until it can slide over the edge of said element, or even push it back.

According to a preferred embodiment of the invention, when the blade 18 comes into possible contact with one of the filamentary reinforcing elements 14, it is immobilized and the blade holder 20 continues its movement towards the closed position by compressing the elastic means 32. When the elastic means exert sufficient stress on the blade, the blade pushes back said element 14, then slides over its edge.

The intermediate product 12 is cut during the closing of the mould 34. The cut intermediate products are then cured in each of the moulding cavities 36.

Other variants and embodiments of the invention can be envisaged without departing from the scope of its claims.

1.-10. (canceled)

11. A device (10) for cutting an intermediate product (12) made of rubber, the intermediate product comprising filamentary reinforcing elements (14) embedded in the rubber and parallel to one another, the cutting device (10) comprising:
a support (16);
a blade (18); and
a blade holder (20) movable between an open position and a closed position in which the blade comes into contact with the support,
wherein the blade (18) is loosely mounted on the blade holder (20) so that the blade is pivotable and/or movable in translation relative to the blade holder.

12. The device according to claim 11, wherein the blade (18) translates only along a yaw direction (26) relative to the blade holder (20), other possibilities of movement of the blade relative to the blade holder being substantially eliminated.

13. The device according to claim 11, further comprising elastic means (32) arranged between the blade (18) and the blade holder (20).

14. The device according to claim 11, wherein the support (16) comprises a notch (36) into which the blade (18) is inserted when the blade holder (20) is brought into the closed position.

15. A curing mold (34) for the intermediate product, the curing mold comprising at least one device (10) according to claim 11, at least two molding cavities (38) for cut intermediate products, and the cutting device being arranged so that the open position of the cutting device (10) corresponds to an open position of the mold (34) and that the closed position of the cutting device (10) corresponds to a closed position of the mold (34).

16. The curing mold according to claim 15, wherein, in the closed position of the mold (34), the blade (18) forms a separation between each cavity (38).

17. The curing mold according to claim 15, wherein a thickness of the blade (18) is less than or equal to 2 mm.

18. The curing mold according to claim 15, further comprising means for positioning the intermediate product (12).

19. A method for molding the intermediate product made of rubber using the curing mold (34) according to claim 15, the method comprising the following steps:
positioning the intermediate product (12) on the support (16) so that the filamentary reinforcing elements (14) are substantially parallel to a longitudinal direction (22) of the blade in the closed position of the mold (3); and
bringing the blade holder (20) into the closed position.

20. The method according to claim 19, wherein, prior to the step of positioning the intermediate product, the intermediate product (12) is pre-cut.
